(19) United States
(12) Patent Application Publication
(10) Pub. No.: US 2006/0177551 A1
(43) Pub. Date: Aug. 10, 2006

(54) SYSTEM AND METHOD FOR EXTRACTING MATERIALS FROM BIOMASS

(76) Inventor: Doug Van Thorre, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/276,054

(22) Filed: Feb. 10, 2006

Related U.S. Application Data
(63) Continuation-in-part of application No. 11/031,670, filed on Jan. 6, 2005.
(60) Provisional application No. 60/652,107, filed on Feb. 11, 2005.

(51) Int. Cl. A23L 2/02

(52) U.S. Cl. 426/489

(57) ABSTRACT

One embodiment described herein includes a method for extracting pericarp, endosperm, bran and germ, from corn kernels comprising hydrating the corn kernels; extracting the bran from the biomass before extracting the germ; and extracting the endosperm, wherein the extraction is based upon a capacity of endosperm particles to selectively pass through, or be retained on a sieve having a standard hole size, wherein endosperm particles are extracted in one or more endosperm streams.

### RELATED APPLICATION

This application claims priority to U.S. Provisional Application Ser. No. 60/652,107, filed on Feb. 11, 2005, and is a Continuation in Part of U.S. application Ser. No. 11/031,670, filed on Jan. 6, 2005, which is incorporated herein by reference.

### FIELD

Embodiments described herein relate to systems and methods for separating materials from biomass.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to any software and data as described below and in the drawings that form a part of this document: Copyright 2005, Biorefining, Inc. All Rights Reserved.

### BACKGROUND

Since time immemorial, biomass such as grains of wheat or kernels or corn, have been ground to make flour. In more recent times, biomass such as soybeans have been pressed to extract oil, while corn kernels have been steeped in water and have been ground to separate bran.

Plants have been ground without water, i.e. by dry grinding, to produce ethanol, carbon dioxide, and a variety of high-fiber content animal feeds. The high-fiber animal feeds are manufactured from fermentation residuals, i.e. the stillage. Whole stillage is centrifuged or screened to produce distillers' wet grain (DWG) which is a denser material, and thin stillage, which is a less dense material. The DWG is typically combined with condensed thin stillage, dried and sold as distillers' dried grains with solubles. By contrast, wet millers produce corn oil, gluten meal, and corn gluten feed. Many wet millers also produce a variety of products from starch in addition to ethanol.

These types of processes have been developed without any regard for the elegant structures and architecture of the biomass. As a consequence, thousands of years of evolutionary development of the structures within the biomass have been ground, pounded, and pressed out of existence in order to extract oil or flour.

### BRIEF DESCRIPTION OF FIGURES

FIG. 1 is a cross-sectional view of a corn kernel.

FIG. 2 is a schematic view of one method embodiment for separation of core components of a corn kernel.

FIG. 3 is a schematic view of a method for separation biomass components based upon their relationship with a membrane.

FIGS. 4A, 4B and 4C are schematic views of one extraction method.

FIG. 5 is a schematic view of another embodiment for separation of biomass components.

FIG. 6 illustrates a corn bran/fiber product made by a process embodiment described herein.

FIG. 7 illustrates a corn endosperm product made by a process embodiment described herein.

FIG. 8 illustrates a corn germ product made by a process embodiment described herein.

FIG. 9 illustrates a modified Dried Distillers Grain, DDG, product made by a process embodiment described herein.

### DETAILED DESCRIPTION

Methods, apparatus and systems for extraction of a variety of materials from biomass are described herein. In the following description, numerous specific details are set forth. However, it is understood that embodiments of the invention may be practiced without these specific details. In other instances, well-known circuits, processes, structures, and techniques have not been shown in detail in order to avoid obscuring the understanding of this description. Note that in the description, references to “one embodiment” or “an embodiment” mean that the feature being referred to is included in at least one embodiment of the invention. Further, separate references to “one embodiment” in this description do not necessarily refer to the same embodiment; however, neither such embodiments are mutually exclusive, unless so stated and except as will be readily apparent to those of ordinary skill in the art. Thus, the invention described herein may include any variety of combinations and/or integrations of the embodiments described herein. Moreover, in this description, the phrase “exemplary embodiment” means that the embodiment being referred to serves as an example or illustration.

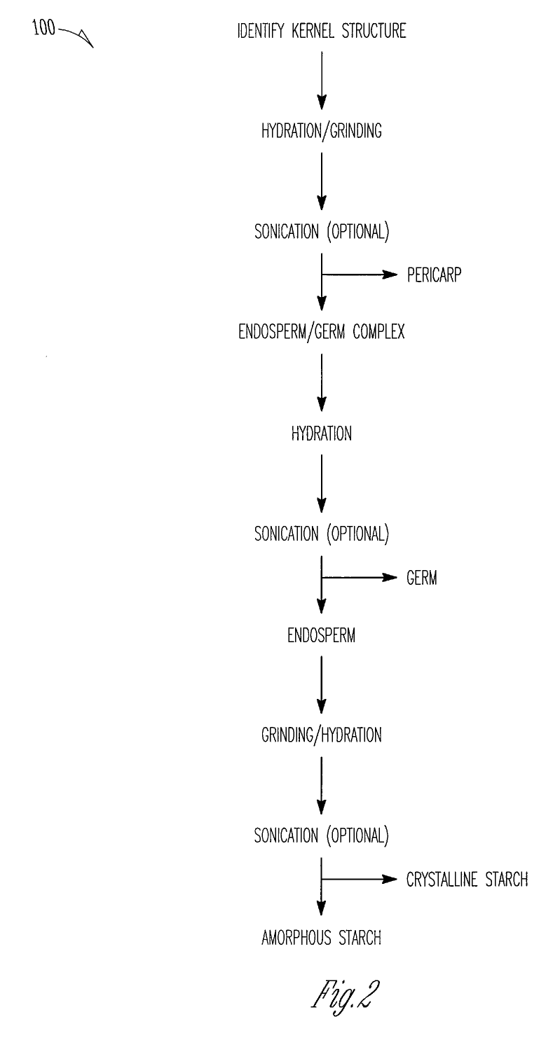

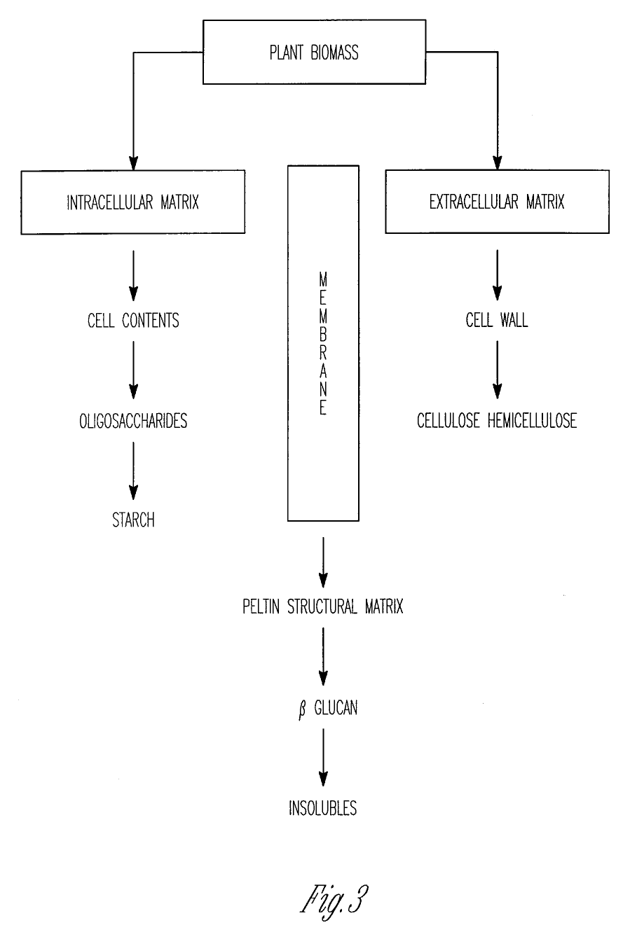

One method embodiment of the invention, illustrated at 100 in FIG. 2 for biomass extraction includes identifying core biomass physical structures and identifying crystalline structural components, amorphous structural components and intra-/extra- cellular components both crystalline and amorphous of the biomass, such as is shown in FIG. 3. Identifying the core biomass structures includes characterizing the architecture of the biomass in its physical, functional, mechanical and chemical aspects. In one exemplary embodiment, the core biomass components of a corn kernel are discussed herein. It is understood, however, that any biomass is capable of being characterized in the manner described herein.

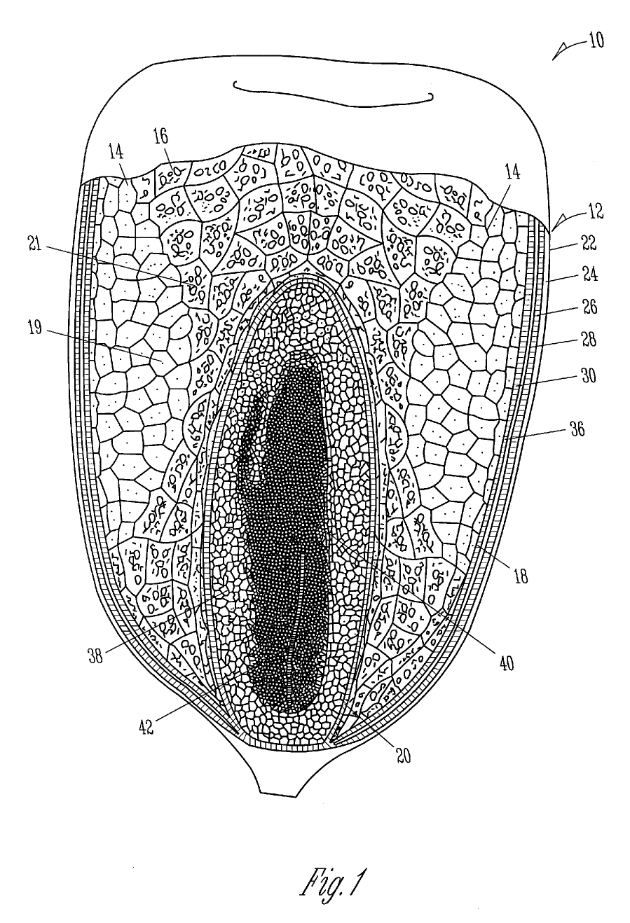

A corn kernel includes components such as a pericarp 12, endosperm 18, and germ 20, shown in one embodiment, in FIG. 1. The pericarp 12 includes a plurality of outer layers that form a “coat” that protects the kernel. The pericarp 12 makes up about six percent of the kernel and includes about 73 percent of insoluble non-starch carbohydrate with 16 percent fiber, 7 percent protein and 2 percent oil. Specific components of the pericarp 12, shown in FIG. 1, include an epidermis 22, a mesocarp 24, cross cells 26, tube cells 28 a testa or seed coat 30 and an aleurone layer 36, which is part of the endosperm but may be separated with bran.

The endosperm 18 includes corn grits and comprises about 80 to 84 percent of the corn kernel. The endosperm contains about 85 percent starch and up to 12 percent protein. The kernel 10 includes both hard, horny, outer endosperm and soft, inner endosperm. The endosperm 18 includes a horny endosperm 19 and floury endosperm 21. The endosperm 18 also includes cells filled with starch granules in a protein matrix. The starch components in the endosperm include crystalline starch 14 and amorphous starch 16.

The corn kernel 10 also includes the germ 20 that makes up about 10 to 14 percent of the kernel. Most of the oil in the corn kernel, 81 to 86 percent, is in the germ. The germ 20 also includes protein and carbohydrate. The germ includes components such as a scutellum 38, plumela or rudimentary shoot or leaves 40 and radicle or primary root 42. The germ 20 is the living component of the corn kernel 10.

Some method embodiments include identifying components for extraction. The components may be structural components such as the pericarp, endosperm, or germ, or cellular components such as crystalline starch or germ DNA or phospholipids, or both. The components are, for some embodiments, the native structures and chemicals of the kernel, substantially unchanged by processing.

For some embodiments, the method includes separating the crystalline structural components from the amorphous structural components by methods that include grinding. In particular, the core biomass structures are ground to a size approaching the size of crystals, including microcrystals, of the crystalline components. For other embodiments, biomass structures are broken down within predefined grinding ranges. By “broken down” it is meant that the components' physical structures are destroyed.

In one embodiment, the pericarp of the corn kernel is hydrated with water in a quantity that softens the pericarp. The water is added, for some embodiments, by spraying the pericarp so that the pericarp is hydrated without free or excess water. Once the pericarp is hydrated, the pericarp is subjected to grinding in order to separate the pericarp from the remaining kernel, which is the endosperm/germ complex. For some embodiments the water may be used as a medium for energy transfer. In this case, water is added in an amount that would yield free-standing water, which would subsequently be separated from the hydrated corn and recycled. For some embodiments, the pericarp is separated from the endosperm/germ complex with grinding and ultrasonic exposure in order to make a clean separation while doing minimal damage to the remaining kernel chemical structure. With this embodiment, the “bran” component of the corn kernel is separated early in the biomass treatment process. The “bran” is, for some embodiments, separated first.

For some embodiments, the pericarp is hydrated with a protonated and/or hydroxylated clustered water, one source of which is IP3 Corp. For some embodiments, the pericarp is disrupted by cryogenic freezing. Once the pericarp is disrupted by one or more of hydration, grinding, clustered water or cryogenic freezing, specific components are extracted from the disrupted pericarp 12, for some embodiments, by aspiration, sonication and selective solublization. For other embodiments, the specific components are extracted by sieving.

The separated pericarp 12 is, for some embodiments, further processed in order to extract specific materials as described below. The pericarp removal is performed in a manner that accommodates the symmetry of kernels of corn generally, and, for some embodiments, specific variations in symmetry of the kernels.

Once the protective cover of the pericarp 12 is removed, the endosperm 18 including crystalline starch 14 and amorphous starch 16, along with the germ 20, are exposed. This portion of the corn kernel is the germ/endosperm (G/E) complex. The germ/endosperm complex is treated in order to separate the germ from the endosperm. In one embodiment, the germ/endosperm complex, is hydrated without forming significant free or excess water. In particular, the germ/endosperm complex is hydrated to a degree that softens the binder binding the germ to the endosperm. In one embodiment, the hydrated germ/endosperm complex is subjected to grinding or milling in order to separate the germ from the endosperm. The grinding or milling occurs after hydration for some embodiments and concurrent with hydration for other embodiments. For some embodiments, separation occurs with sonication. For some embodiments, hydration is performed using clustered water.

The crystalline starch 14 of the endosperm has been found to include microcrystals, about 40 microns in diameter, that include a minimum of about 65% starch and up to about 10% protein. The crystalline starch microcrystals include layers of crystalline starch laid down like layers of a pearl or like tree rings. Within the pearl-like microcrystals are oil-bearing protein encapsulates.

The endosperm is ground to separate the crystalline starch from the amorphous starch. In one embodiment, the endosperm is ground to generate particles within a size range of 40 microns or larger, the approximate size of the microcrystals in the crystalline starch. In one embodiment, the particles are ground to a 40 micron size plus or minus 5 microns or larger depending upon downstream processing parameters. The grinding is, for some embodiments, performed in a microgrinder. One microgrinder usable in the process embodiments described herein is described in U.S. Pat. No. 5,410,021. With the microgrinder, the starch microcrystal integrity is maintained and the amorphous starch is separated from the starch microcrystals with, in one embodiment, sonication. While microgrinding is described, it is understood that grinders capable of grinding to sizes of 100 microns or less are suitable for embodiments described herein. For some embodiments, one or both of the fractions, starch microcrystals and amorphous starch, are saved for further treatment. For some embodiments, a particle size of less than 1000 microns is desired. For other embodiments, a particle size within the range 100-500 microns is desired.

For other embodiments, the endosperm is ground to 75 to 80 microns to make a ground fraction. The ground fraction is solubilized in ethanol and sonicated for separation of the crystallized starch from the protein component. For other embodiments, the ground fraction is not sonicated. As a result, the microparticles of starch are extracted. The starch microparticles may be cross-linked and used as carriers for pharmaceuticals, nutraceuticals and other materials.

The endosperm stream may be combined, in one embodiment, with a very small stream of imperfectly separated materials, which contains significant portions of fiber, starch, protein, and oil. This feedstream is suitable for fermentation by yeast to produce alcohol. The byproduct of this fermentation, high protein dried distillers grains, has unique properties to be described further.

The germ fraction of the germ/endosperm complex is, for some embodiments, subjected to solubilizing and grinding to separate the nucleic acid, DNA and RNA, and protein from the remaining portion of the germ. The germ also includes oil, present in oil bodies within the germ. For some embodiments, oil in the oil bodies is non-destructively extracted by solubilizing the oil into a solvent fraction with or without sonication or electromagnetic wave exposure (radiation). Solvents may be used in a supercritical or subcritical state, and may include hexane, propane, carbon dioxide, and other suitable solvents in either gas or liquid form. The oil can also be removed by traditional methods that include expeller pressing or extrusion. For some embodiments, phospholipids are also extracted into a solvent fraction.

While a corn kernel is described, it is understood that method embodiments are usable to separate constituents of any biomass. The method includes identifying the architecture of the biomass, the core structures and the mechanisms that order the core structures within the biomass. The method also includes sequentially separating the core components without destroying core components. The separation includes grinding or milling, for some embodiments, within a size range that is not less than the size of the selected core component. For some embodiments, the separation also includes sonication and/or exposure to electromagnetic radiation. For some embodiments, the separation includes hydration, in some instances, with clustered water.

Once the core components are separated, constituents or structures or both, within one or more of the core components are separated from the core component. In the case of a corn kernel, components such as the epidermis 22, mesocarp 24, cross cells 26, tube cells 28, testa 30, and aleurone layer 36 are, for some embodiments, separated from the pericarp 12. In one embodiment, in preparation of separation, the components are categorized as being structural components, intercellular components, or extracellular components. Other components of the pericarp may be separated using a combination of hydration without free water, microgrinding, sonication, cryogenic freezing, exposure to electromagnetic radiation, and selective solublization.

The epidermis 22 and mesocarp 24 of a corn kernel are made of closely adherent, long and fibrous thick-walled cells with no intercellular spaces. These cells are resistant to crack and breakage. The aleurone layer, which is the outermost layer of the endosperm, contains no intercellular spaces. The aleurone layer contains protein and oil but no starch.

For some embodiments, after removal from the bulk of the corn kernel, the pericarp is further separated from adhering non-pericarp corn components by sonication and/or sifting. Once the pericarp is separated, for some embodiments, it is partially dried. Drying reduces the total moisture level from between 15% to 75% of the starting pericarp moisture level. Any of a variety of times and temperatures may be used to dry the pericarp product, as long as the product is not scorched or blistered, and an adequate amount of moisture is removed in a desired time period. The pericarp product may be air dried or osmotically dried. One drying temperature range occurs between 200° F.-300° F., with the drying time ranging between 15 minutes and 45 minutes. An amount of a partially dried pericarp product is thereby produced.

The dried pericarp is, for some embodiments, subjected to freezing, such as by cryogenic freezing, or is subjected to mechanical separation such as grinding and cryogenic freezing. Cryogenic freezing includes exposing the pericarp product to temperatures equal to approximately −321° F. (in liquid nitrogen) for about one minute. Liquid nitrogen or liquid carbon dioxide may be used. Cryogenic freezers are purchasable from any of a variety of commercial providers. Cryogenic freezing produces a fresh crisp product. It is believed that cryogenic freezing prevents water in the mesocarp product from expanding and thereby breaking the cell wall. Any method that maintains the cell wall integrity during freezing is usable. For some embodiments, the mesocarp is subjected to microgrinding for exposure of internal components such as phospholipids. Phospholipids are extracted from the mesocarp by extraction with ethanol in a microreactor, in some embodiments.

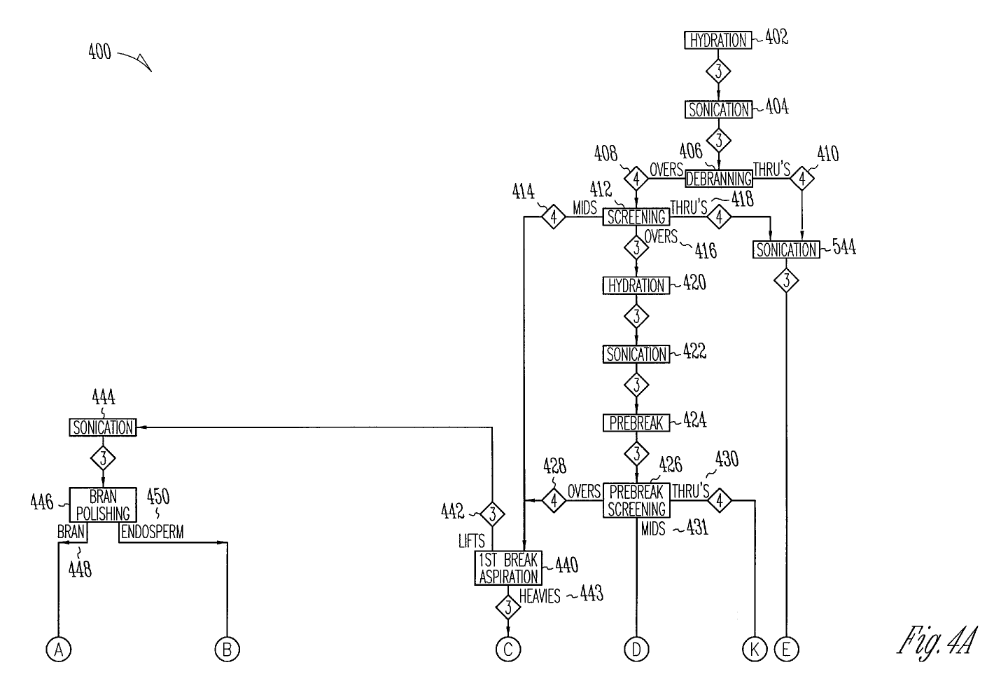

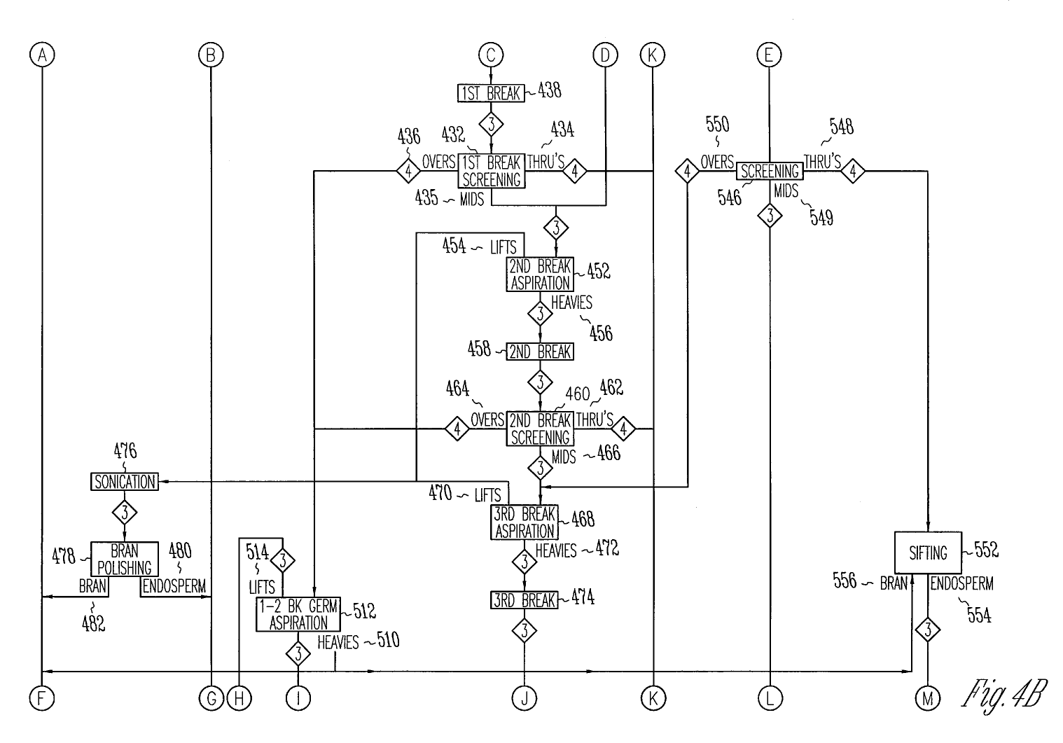

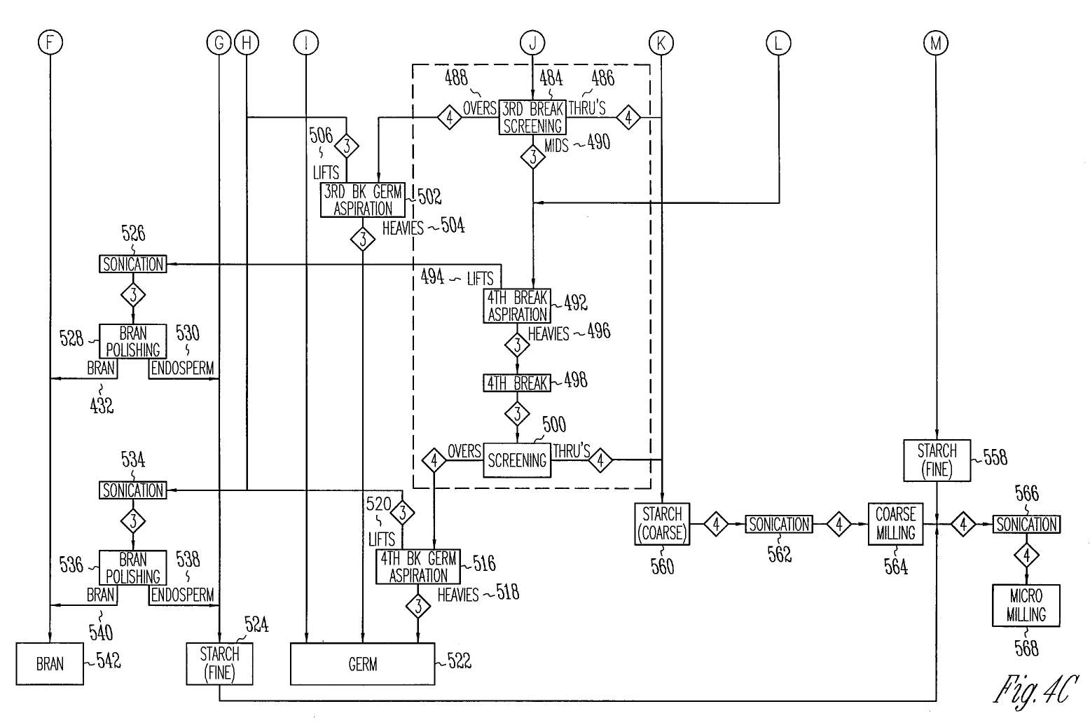

One biomass extraction embodiment is illustrated schematically at 400 in FIG. 4A. As used herein, the term “overs” refers to particles having a size that is too great to pass through holes of a mesh screen. These particles remain on the screen. As used herein, the term “thrus” refers to particles that are small enough to pass through holes of a screen. As used herein, the term “mids” refers to particles having a weight, size, or shape that may pass through a first screen but are retained on a second screen, the second screen having smaller openings that the first screen. As used herein, the term “lifts” refers to a lighter portion of material removed from a stream via aspiration with air. As used herein, the term “heavies” refers to the remainder of an aspirated stream, wherein particles are largely heavier than the “lifts” removed from them.

The extraction process 400 is initiated by hydration of biomass, such as a seed or kernel, shown at 402. For some embodiments, the hydration softens the pericarp of the seed or kernel. For some embodiments, the hydration is performed by spraying the biomass with water. The hydration 402 is followed by sonication 404, for some embodiments, to form sonicated biomass. Sonication further loosens and separates biomass components loosened from their native structure by hydration. For other embodiments, hydration and sonication occur substantially simultaneously. For further embodiments, sonication may or may not be used.

The biomass, which may be sonicated, is subjected to debranning 406, forming heavier, larger particles, described herein as debranned overs 408 and lightweight, smaller particles, described herein as debranned thrus 410. The debranned overs 408 are screened at 412, forming fractions of screened, debranned mids 414, screened debranned overs 416 and screened debranned thru's 418. Screening as described herein is performed by screening devices such as those manufactured by companies such as Rotex, of Cincinnati, Ohio, and Superbrix, located in Barranquilla-Columbia. While Rotex and Superbrix are described herein, it is understood that other screening equipment is suitable for use in embodiments described herein.

The debranned thrus fraction 410 is combined with debranned overs screened thrus 418 and is optionally subjected to sonication at 544. This stream is then screened at 546, shown in FIG. 4B to form a debranned thrus fraction 548, a debranned overs fraction 550 and a debranned mids fraction 549.

The screened debranned overs 416 are hydrated at 420 and, for some embodiments, are sonicated at 422. The stream is then subjected to a prebreak at 424 and prebreak screening at 426 to form prebreak overs 428, prebreak thrus 430 and prebreak mids 431. The prebreak overs 428 are combined with debranned mids 414 subjected to a first break aspiration 440 generating lifts fraction 442 and a heavies fraction 443. The first break aspiration lifts fraction 442 is optionally subjected to sonication 444 in FIG. 4A and a bran polishing step 446, ultimately separating the biomass into bran 448 and endosperm 450. The heavies fraction 443 is subjected to a first break at 438, shown in FIG. 4B and is screened in a first break screening at 432. This forms a first break overs 436, a first break mids 435, and a first break thrus 434.

The first break mids fraction 435 and prebreak mids fraction 431 are combined and treated in a second break aspiration at 452, in FIG. 4B, creating a second break heavies fraction 456 and a second break lifts fraction 454. The second break heavies fraction 456 is treated in a second break 458 and a second break screening 460. The second break screening produces a second break overs fraction 464, a second break thrus fraction 462 and a second break mids fraction 466. A prebreak thrus fraction 430, a first break thrus fraction 434 and a second break screening thrus fraction 462 are substantially comprised of coarse starch 560, shown in FIG. 4C. For some embodiments the coarse starch 560 is sonicated at 562 and/or subjected to coarse milling 564. After coarse milling the starch is combined with fine starch 524 and 558, and is sonicated at 566 and/or subjected to micromilling 568.

A second break screening overs fraction 464 is combined with a first break screen overs 436 and treated in a 1-2 BK germ aspiration process at 512 to form a germ aspiration lifts fraction 514 and a germ aspiration heavies fraction 510. The germ aspiration heavies fraction 510 is added to a germ fraction 522.

The second break mids fraction 466 is combined with a debranned thrus screening overs fraction 550 and is subjected to third break aspiration 468 forming a third break aspiration lifts fraction 470 and a third break aspiration heavies fraction 472. The third break aspiration lifts fraction 470 and is combined with the second break aspiration lifts fraction 454, optionally sonicated at 476 and subjected to bran polishing at 478 to form bran 482 and endosperm 480. The endosperm 480 is added to the fine starch component 524.

The third break aspiration heavies fraction 472 is subjected to a third break at 474 and a third break screening at 484 in FIG. 4C to form a third break overs fraction 488, a third break thrus fraction 486 and a third break mids fraction 490. The third break thrus fraction 486 is added to the coarse starch stream 560 that is, for some embodiments, sonicated at 562 and/or coarsely milled at 564. The third break overs fraction 488 is subjected to a third break germ aspiration at 502 forming a germ aspiration lifts fraction 506 and a germ aspiration heavies fraction 504. The germ aspiration heavies fraction 504 is added to germ at 522.

The third break mids fraction 490 is combined with debranned thrus screend mids 549 and subjected to a fourth break aspiration at 492 to form a fourth break lifts fraction 494 and a fourth break heavies fraction 496. The fourth break lifts fraction 494 is optionally sonicated at 526 and subjected to bran polishing at 528 to be separated into a bran fraction 432 and an endosperm fraction 530. The fourth break heavies fraction 496 is subjected to a fourth break at 498 and screening at 500. A thrus fraction from the screening 500 is added to the coarse starch 560. An overs fraction from the screening 500 is subjected to a fourth break germ aspiration 516 to form a fourth break germ aspiration lifts fraction 520 and a fourth break germ aspiration heavies fraction 518. The fourth break germ aspiration heavies fraction 518 is added to a germ fraction 522.

The fourth break germ aspiration lifts fraction 520 is combined with third break germ aspiration lifts 506 and 1-2 break germ aspiration lifts 514. This combined stream is subjected to sonication 534 and/or bran polishing 536 to form bran 540 and endosperm 538.

In one embodiment, similar streams are combined as is shown in FIG. 4A-4C. Bran streams 446, 478, 556, 532, and 540 are combined to form Bran at 542. Similarly, Germ streams 510, 504, and 518 are combined to form Germ at 522. Finally, all starch sources 450, 480, 530, 538, 548, and 554 are combined. For some embodiments, this stream is sonicated and/or micromilled.

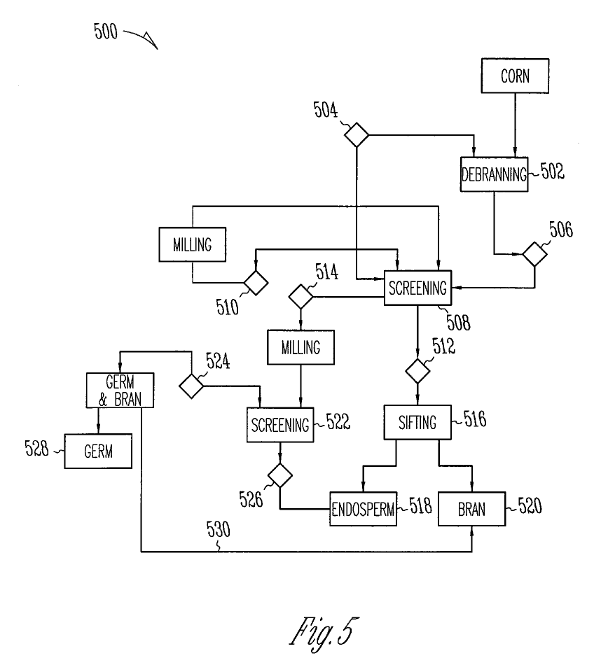

Another embodiment of a process for extraction of components from corn is illustrated at 500 in FIG. 5. Corn is debranned at 502 to form an overs fraction 504 and a thrus fraction 506. The overs fraction 504 and thrus fraction 506 are screened at 508 to form a +4 overs fraction 510, a starch rich thrus fraction 512 and a −4/+20 mids fraction 514. The mids fraction 514 includes bran in a size range of +6/+8 and germ in a size range of +6/+8.

The overs fraction 510 is subjected to milling and is fed again to screening at 508. The thrus fraction 512 has a size of −20 and is subjected to sifting 516 to form a bran fraction 520 and an endosperm fraction 518. The mids fraction 514 is subjected to milling again and is screened at 522 to form an overs fraction 524 and a thrus fraction 526. The thrus fraction 526 includes endosperm falling within a screen size range of −12, −14, and −16. The overs fraction 524 includes a mixture of germ and bran. The screen size falls within a range of +6, +8. A germ fraction 528 is separated from a bran fraction 530 by aspiration.

Products made by process embodiments described herein have a higher purity as compared to products made by conventional processes and a quality akin to native structures of plant components. The tables shown below indicate the compositions obtained in one embodiment, as well as ranges for each component that could be achieved due to variations in raw materials or processing efficiency. The products included here all originate from the grain fractionation process. Although some of these products are produced through other processes such as germ oil expelling and fermentation, they possess unique characteristics different from traditional products of oil expelling and fermentation.

Endosperm Stream
45-55 lb/bu

| | |
|---|---|
| Embodiment | Typical Range |

| | % wb | % db | lo db % | hi db % |
|---|---|---|---|---|
| Moisture | 19.7% | | | |
| Starch | 68.4% | 85.2% | 75.0% | 95.0% |
| Protein | 6.7% | 8.3% | 5.0% | 12.0% |
| Oil | 2.3% | 2.9% | 1.0% | 4.0% |
| Fiber | 2.4% | 3.0% | 1.0% | 5.0% |
| Ash | 0.5% | 0.6% | 0.0% | 2.0% |
| Totals | 100.0% | 100.0% | | |

Germ Meal
3.0-7.0 lb/bu

| | |
|---|---|
| Embodiment | Typical Range |

| | | | |
|---|---|---|---|
| % wb | % db | lo db % | hi db % |

| | | | | |
|---|---|---|---|---|
| Moisture | 6.7% | | | |
| Starch | 39.8% | 42.6% | 30.0% | 50.0% |
| Protein | 19.8% | 21.3% | 15.0% | 25.0% |
| Oil | 6.0% | 6.4% | 3.0% | 15.0% |
| Fiber | 18.7% | 20.1% | 15.0% | 25.0% |
| Ash | 9.0% | 9.6% | 5.0% | 12.0% |
| Totals | 100.0% | 100.0% | | |

Germ
3.0-7.0 lb/bu

| | |
|---|---|
| Embodiment | Typical Range |

| | % wb | % db | lo db % | hi db % |
|---|---|---|---|---|
| Moisture | 23.2% | | | |
| Starch | 25.0% | 32.6% | 25.0% | 40.0% |
| Protein | 12.5% | 16.3% | 10.0% | 20.0% |
| Oil | 21.8% | 28.5% | 25.0% | 40.0% |
| Fiber | 11.8% | 15.3% | 12.0% | 20.0% |
| Ash | 5.6% | 7.3% | 3.0% | 10.0% |
| Totals | 100.0% | 100.0% | | |

Crude Oil
0.6-1.4 lb/bu

| | |
|---|---|
| Embodiment | Typical Range |

| | % wb | % db | lo db % | hi db % |
|---|---|---|---|---|
| Moisture | 2.5% | | | |
| Starch | 0.5% | 0.5% | 0.0% | 1.0% |
| Protein | 0.2% | 0.2% | 0.0% | 1.0% |
| Oil | 96.5% | 99.0% | 99.0% | 100.0% |
| Fiber | 0.2% | 0.2% | 0.0% | 1.0% |
| Ash | 0.1% | 0.1% | 0.0% | 1.0% |
| Totals | 100.0% | 100.0% | | |

Dried Bran
2.5-5.0 lb/bu

| | |
|---|---|
| Embodiment | Typical Range |

| | % wb | % db | lo db % | hi db % |
|---|---|---|---|---|
| Moisture | 10.0% | | | |
| Starch | 16.4% | 18.3% | 8.0% | 25.0% |
| Protein | 5.6% | 6.2% | 3.0% | 10.0% |
| Oil | 3.2% | 3.6% | 2.0% | 8.0% |
| Fiber | 63.7% | 70.8% | 60.0% | 85.0% |
| Ash | 1.1% | 1.2% | 0.5% | 3.0% |
| Totals | 100.0% | 100.0% | | |

Yeast Cream
0.1-1.0 lb/bu

| | |
|---|---|
| Embodiment | Typical Range |

| | % wb | % db | lo db % | hi db % |
|---|---|---|---|---|
| Moisture | 9.0% | | | |
| Starch | 35.0% | 38.5% | 25.0% | 45.0% |
| Protein | 42.0% | 46.2% | 30.0% | 55.0% |
| Oil | 1.5% | 1.6% | 0.0% | 4.0% |
| Fiber | 5.5% | 6.0% | 3.0% | 10.0% |
| Ash | 7.0% | 7.7% | 3.0% | 10.0% |
| Totals | 100.0% | 100.0% | | |

Composite High Protein DDGs
7.0-12.0 lb/bu

| | |
|---|---|
| Embodiment | Typical Range |

| | % wb | % db | lo db % | hi db % |
|---|---|---|---|---|
| Moisture | 10.0% | | | |
| Starch | 4.6% | 5.1% | 0.0% | 8.0% |
| Protein | 49.4% | 54.9% | 35.0% | 75.0% |
| Oil | 15.3% | 16.9% | 8.0% | 25.0% |
| Fiber | 16.7% | 18.6% | 15.0% | 30.0% |
| Ash | 4.1% | 4.5% | 2.0% | 8.0% |
| Totals | 100.0% | 100.0% | | |

High Protein DDGs (dried)
7.0-12.0 lb/bu

| | |
|---|---|
| Embodiment | Typical Range |

| | % wb | % db | lo db % | hi db % |
|---|---|---|---|---|
| Moisture | 10.0% | | | |
| Starch | 3.3% | 3.7% | 0.0% | 8.0% |
| Protein | 49.7% | 55.2% | 35.0% | 75.0% |
| Oil | 15.8% | 17.6% | 8.0% | 25.0% |
| Fiber | 17.2% | 19.1% | 15.0% | 30.0% |
| Ash | 4.0% | 4.4% | 2.0% | 7.0% |
| Totals | 100.0% | 100.0% | | |

Products obtained by process embodiments described above include the following:

Corn Bran/Corn Fiber:

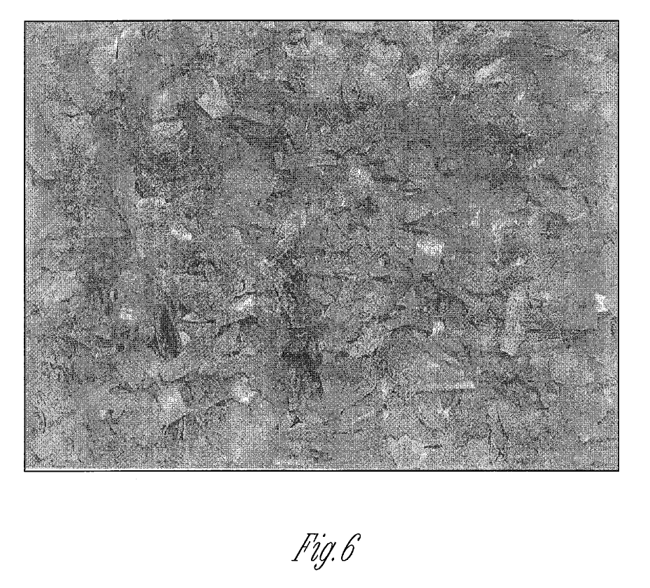

The corn bran/corn fiber product has an appearance that is light tan, and somewhat shiny. Some flakes have strips of amber color. The corn bran/corn fiber product contains 0-2% tip caps. One embodiment of the corn fiber is shown in FIG. 6. The corn bran/corn fiber has an exterior portion which was very smooth. A portion of the fiber in contact with the endosperm has a slightly rough feel. The fiber is comprised of flakes that are usually fairly flat. Some fiber particles are long, thin slivers or irregular shapes with relatively equal length and width dimensions. Length varies from approximately 2 to 10 mm and width varies from approximately 1 to 7 mm.

Characteristics: The corn bran/fiber separated by the grain fractionation process described herein is distinguishable from other products produced by different processes in that the bran/fiber has no foul odor. The material is dry and fluffy immediately after processing. The material maintains this dry and fluffy state even after storage for several months under reasonable conditions for grain/feed storage. The material does not include quantities of sugars or acids other than what is naturally occurring in the layers comprising the bran/fiber. The level of protein in this bran/fiber product is lower than that in bran fiber or gluten feed produced in wet-milling processes.

The process by which this product is produced uses only water; there are no added chemicals. The feedstock material includes the epidermis, mesocarp, cross cells, tube cells, and seed coat. The bran/fiber may in some instances include an aleurone layer.

Applications: The corn bran/fiber described herein is usable as a feed or food grade ingredient, in its native form or after further processing. It is high in dietary fiber. Additionally, it serves as an exceptional raw material for extraction of components, such as cellulose, hemicellulose, lignin, corn fiber oil, corn bran oil, arabinoxylans, polysaccharides, and other functional chemicals. Some of these compounds, including arabinoxylans, corn fiber oil, corn bran oil, and other materials, may have neutraceutical or pharmaceutical applications. The bran/fiber described herein has a cleanliness, dryness, and purity that has heretofore not been possible to produce. The corn fiber may also serve as an excellent energy source.

Corn Germ

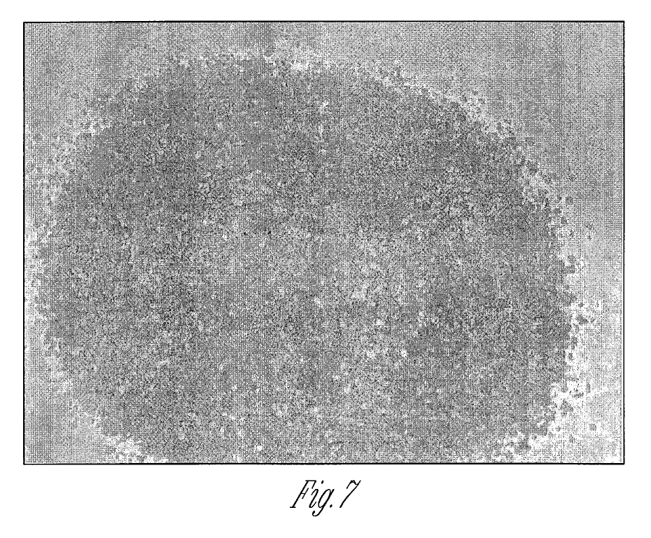

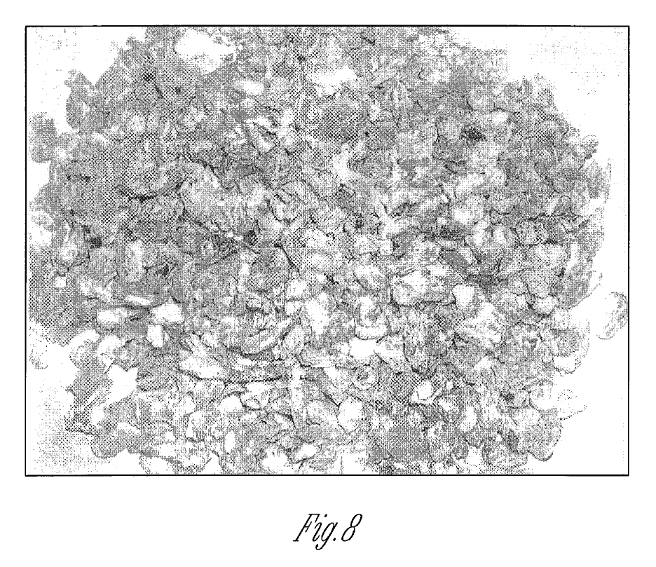

The appearance of the corn germ fraction is grey and yellow. The particles are not smooth as shown in FIG. 7. Some particles have black tip caps attached. Some particles have small bits of endosperm or bran attached. The texture includes a slightly fatty texture on an exterior of the corn germ particles. The size and shape of the particles ranges from small fragments of corn germ to large, whole germ. Dimensions of particles are at least one mm on all sides, and may be up to ten mm or more. Some particles are flat. Other particles are round.

Characteristics: Unlike corn germ obtained from a wet milling process, the corn germ product obtained by the process described herein includes all the components of the germ in its native state, including oil, protein, starch, sugars, and minerals. The corn germ product has not been altered or contaminated as a wet-milled product would be by chemicals present in steep water or by minor fermentation processes that occur during the wet mill process. Specifically, the amino acid profile of the corn germ product described herein is more like the native germ, whereas the amino acid profile of wet-milled germ is significantly altered.

Applications: Corn germ described herein is usable to produce oil by conventional or novel methods. Additionally, the corn germ serves as an exceptional feedstock for extraction of sugars, minerals, proteins, amino acids, fatty acids, and starch because the germ has not been altered by processing chemicals.

Crude Corn Oil

When the corn germ is pressed, a crude vegetable oil is produced. This product is dark brown and opaque and contains a small amount of insoluble fine material. Additionally, a light brown layer that is slightly thicker than the bulk of the oil is produced when the product is allowed to settle. Other methods for oil production will yield a product with different attributes.

Applications: This material is suitable for refining by conventional or novel methods to produce biodiesel or edible oil. Oil produced by some methods may not need further refining to produce a food product.

Corn Germ Meal

The meal remaining after oil extraction by expeller pressing has a granular texture and is medium brown in color. It gives off an odor similar to peanut butter. Other methods for oil extraction will yield a product with different attributes

Applications: Corn germ meal can be used as an animal feed. Additional chemical components can also be separated. The germ meal can serve in some instances as a feedstock for extracting a high-quality corn protein isolate. This corn protein isolate is a light colored powder with no off odors or flavors and a favorable amino acid profile that compares well with egg white protein. The germ meal, or a residue after protein extraction, can be used as a fermentation feedstock as it contains starch. The germ meal can also be mixed with other products such as the corn bran/fiber or high protein DDGs, to create feeds with novel characteristics.

Corn Endosperm

Appearance and Texture: Streams of the process described herein are distinguishable in having predictable and consistent appearance and properties. One stream (endosperm from prebreak, i.e., stream 430), although taken as thrus from a large-mesh screen, has a very light yellow color and a very soft, floury texture. This stream of material includes a small portion of larger endosperm pieces and a larger portion of floury endosperm which is more amorphous and less crystalline than a hard, horny endosperm. The middle cuts, shown as streams in the first break, second break, third break, i.e., streams 434, 462, and 486, have a harder, more granular nature as shown in FIG. 7. These cuts include over 75% of the material. Each individual particle of the corn endosperm shows a darker yellow, hard portion and a small amount of white, chalky material on another portion of the particles. These particles are at the interface between hard and soft endosperm and include some of both types of material.

Size/Shape: Prior to grinding, the size of the material particles ranges from −12 mesh to −20 mesh or smaller. The shape is irregular and granular for most particles and smoother and more powdery for other particles. After grinding the particles, a fine, homogenous, light yellow powder is formed. The powder has a very high angle of repose.

Characteristics: The endosperm product described herein has been extracted without separation or fractionation of the seed endosperm into sub-components. In addition, the endosperm has not lost any starch or soluble material to steepwater as happens in a wet-mill process. Prior art dry milling techniques found in the food industry typically isolate a grit product that contains primarily hard endosperm and a flour product that contains non-starch components. These sub-components cannot be combined to represent the complete and relatively pure endosperm.

Conversely, the endosperm fractions from the grain fractionation process described herein produce separate streams each with unique endosperm characteristics that when combined represent the entire native endosperm with very little loss to other co-product fractions.

The ground endosperm product described herein exhibits some unique characteristics, including a high absorption when slurried with water, which results in a very viscous slurry. The ground endosperm material also has a very slight oily feel when rubbed between the fingers. It is unusual to find “pure endosperm” in a virgin, dry state such as is described herein. Additionally, the amino acid profile in the endosperm product described herein is substantially identical to the amino acid profile in native corn endosperm, as none of the treatments used to produce this endosperm product remove or degrade any amino acids. The grinding step makes the hard crystalline starch, sometimes referred to “resistant” starch, available for fermentation.

Applications: The endosperm material is usable as a pure, low-cost feedstock for fermentations to produce ethanol, other alcohols, and organic acids. Additionally, because of its purity and lack of process-induced degradation, the endosperm material serves as an exemplary feedstock for production of native starches and modified starches, separation of amorphous and crystalline starches, and extraction of zein, carotenoids, other color bodies, non-zein proteins, oil, amorphous starch, crystalline starch, and other functional chemicals. Certain chemicals such as oil, carotenoids, and other materials may have neutraceutical or pharmaceutical applications. The zein produced from this endosperm product has an advantage over zein produced from whole corn in that the level of oil present to interfere with the protein extraction is much lower. The result is a purer, more easily produced zein product with applications ranging from food and pharmaceuticals coatings to biodegradable replacement for plastic resins.

Product quality of the endosperm depends on processing parameters and desired qualities for downstream processing. The endosperm fraction is substantially free from bran and germ. Additionally, the endosperm fraction is capable of being fermented. It is believed that the endosperm product described herein is uniquely capable of fermenting in a substantially pure form. Due to the particle size obtained with coarse grinding or microgrinding and the lack of significant portions of bran and germ, this material is an especially suitable feedstock for fermentation methods that make use of unique enzymes to reduce or eliminate the liquefaction step. The endosperm fraction described herein includes about 95% of the endosperm.

A remaining endosperm stream, a 5% fiber/fat stream, that includes up to 5% of the endosperm material includes about 50 percent fiber and an elevated fat content. The 5% fiber/fat stream contributes about half of the fiber found in the Dried Distillers Grains. The purity of the composite endosperm stream is affected by this 5% fiber/fat stream. When extraction technologies for production of protein or other materials from the endosperm are employed, higher product purity may be obtained by maintaining the 5% fiber/fat stream separately.

Modified DDGs

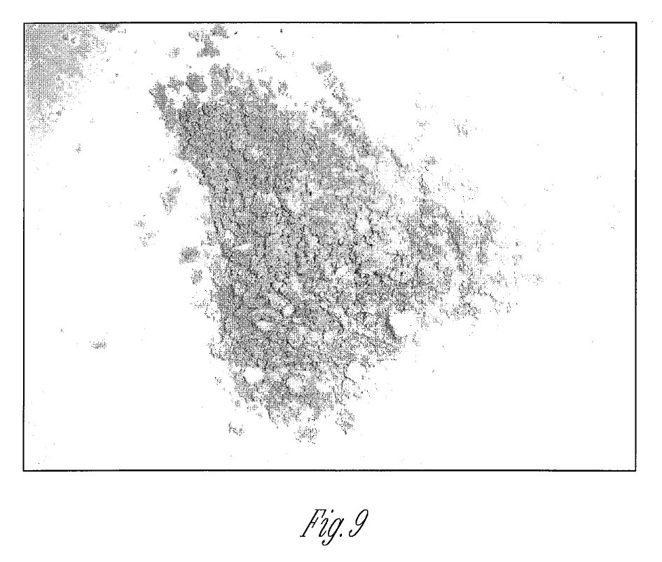

The modified DDG product was light yellow crumbly granular material as shown in FIG. 9. The modified DDG product had a texture that was grainy like fine sand.

Modified DDGs are a residual fraction that is formed when the endosperm fraction is fermented to produce ethanol. A unique feature of the process described herein is that, in addition to a more favorable feed composition, there is much less residual non-fermented material per bushel of corn processed, when compared to prior art dry-grind ethanol processes. Production of VOCs from drying the wet-cake nonfermentable material falls accordingly.

The modified DDG product includes a minimum of 35% protein and may contain up to 75% protein. For some embodiments it contains approximately 50-55% protein. The modified DDG product also contains a maximum of about 18 to 20% lipids. The amino acid profile of this material includes more non-zein residues than corn gluten meal because the protein in endosperm naturally includes some non-prolamins. In conventional wet-milling processes most non-prolamins are stripped away. The modified DDGs product described herein also includes a small residue of germ protein, which is high in non-prolamin protein content. For some embodiments, the amino acid profile is further enhanced by proteins from the germ meal when the germ meal is added to the fermentation feed. The DDGs may agglomerate during the drying process, but milling this modified DDGs product into a fine sand after drying is much easier than doing the same with conventionally-produced DDGs, as the fundamental particle size is much smaller with modified DDGs than with conventionally-produced DDGs. The DDGs may be pelleted for palatability.

Applications: DDGs are typically used as animal feed. The product described herein, depending on order and method of unit operations to progress from a dry endosperm-rich feed material through ethanol production to this residual material (in wet or dry form), serves as an excellent source for extracting carotenoids, other color bodies, zein, proteins, lipids, fatty acids, and other functional chemicals. Additionally, for ethanol fermentations, the amount of residue material with the process described herein is much less than with typical DDGs. This feature makes separation of yeast cream easier. The dried distillers grains also serve as an excellent energy source. In some applications, the DDGs may also be blended with other products including the corn bran/fiber and the germ meal, to create novel feed products.

While specific mechanical and physical processes are described herein, it is understood that physical processes including but not limited to application of pressure through grinding, milling, or impacting, size classification, through screening or air classification, and density separation through air aspiration, gravity tabling, or floatation methods are usable in embodiments described herein.

What is claimed is:

1. A process for extracting pericarp, endosperm, bran and germ, from corn kernels comprising hydrating the corn kernels; extracting the bran from the biomass before extracting the germ; and extracting the endosperm, wherein the extraction is based upon a capacity of endosperm particles to selectively pass through, or be retained on a sieve having a standard hole size, wherein endosperm particles are extracted in one or more endosperm streams.

2. The process of claim 1 wherein the extraction of bran, endosperm, germ and fiber from biomass is free of a use of chemical addition.

3. The process of claim 1, wherein the pericarp is disrupted form the corn kernels by one or more of hydration, grinding, and cryogenic freezing.

4. The process of claim 3, wherein the disrupted pericarp is subjected to one or more of aspiration, sonication, and selective solubilization.

5. The process of clam 1 wherein the pericarp is removed from corn kernels in a manner effective for accommodating the symmetry of the corn kernels.

6. The process of claim 1 wherein a germ/endosperm complex is removed by softening a binder binding the germ to the endosperm.

7. The process of claim 6, wherein the germ is separated from the endosperm by grinding or milling.

8. The process of claim 6, wherein the grinding or milling occurs with one or more of hydration and sonication.

9. The process of claim 7, wherein the endosperm is ground to separate crystalline starch form amorphous starch.

10. The endosperm product of claim 3 wherein the particles are free from added chemicals.
